(19) United States
(12) Patent Application Publication
(10) Pub. No.: US 2025/0308748 A1
(43) Pub. Date: Oct. 2, 2025

(54) DC-DC CONVERTER AND POWER SUPPLY CIRCUIT

(71) Applicant: TDK Corporation, Tokyo (JP)

(72) Inventor: Tomofumi KURODA, Tokyo (JP)

(73) Assignee: TDK Corporation, Tokyo (JP)

(21) Appl. No.: 19/093,195

(22) Filed: Mar. 27, 2025

(30) Foreign Application Priority Data
Mar. 29, 2024 (JP) 2024-056772

(51) Int. Cl. H01F 27/28; H01F 27/24; H02M 3/155

(52) U.S. Cl. CPC H01F 27/28; H01F 27/24; H02M 3/155

(57) ABSTRACT

A DC-DC converter of a power supply circuit can improve characteristics in view of loss reduction by using, as an inductor, a coil conductor of an inductance element including, as a core, a magnetic block configured with crack free magnetic thin strips.

### CROSS-REFERENCE TO RELATED APPLICATION

This application is based upon and claims the benefit of priority from Japanese Patent Application No. 2024-056772, filed on Mar. 29, 2024, the entire content of which is incorporated herein by reference.

### TECHNICAL FIELD

The present disclosure relates to a DC-DC converter and a power supply circuit.

### BACKGROUND

Japanese Patent Application Publication No. 2022-26401 discloses an inductor including a coil conductor and a magnetic core. The magnetic core disclosed in this document has a laminated structure with magnetic thin strips made of amorphous alloy or nanocrystalline alloy laminated.

### SUMMARY

A DC-DC converter according to one aspect of the present disclosure includes a first input terminal and a second input terminal, a first output terminal and a second output terminal, a first switching element connected to the first input terminal, a first circuit provided between the first switching element and the first output terminal, and including a first capacitor and a first inductor connected in series in this order and a second switching element connected between the first capacitor and the first inductor, a second circuit provided between the first switching element and the first output terminal in parallel with the first circuit, and including a third switching element and a second inductor connected in series in this order and a fourth switching element connected between the third switching element and the second inductor, and a second capacitor connected between the first output terminal and the second output terminal. At least one of the first inductor and the second inductor is an inductance element including a first coil conductor, a magnetic body adjacent to the first coil conductor, and a magnetic resin internally including the first coil conductor and the magnetic body. The magnetic body has a laminated structure with a plurality of magnetic thin strips laminated, and each magnetic thin strip is not divided into small pieces by a crack.

A power supply circuit according to one side surface of the present disclosure includes the above DC-DC converter, and an input power supply configured to input a DC voltage of 10V or more between the first input terminal and the second input terminal.

### BRIEF DESCRIPTION OF THE DRAWINGS

FIG. 1 is a circuit diagram of a power supply circuit according to one embodiment.

FIG. 2 is a perspective view of an inductance element used in the DC-DC converter shown in FIG. 1.

FIG. 3 is an exploded view of the inductance element shown in FIG. 2.

FIG. 4 shows the laminated structure of the magnetic block shown in FIG. 2.

FIG. 5 is a circuit diagram of a DC-DC converter which is not voltage-divided by a capacitor.

### DETAILED DESCRIPTION

The inventors have studied on the application of an inductor including a magnetic core with magnetic thin strips laminated to a two-phase DC-DC converter, and as a result, have newly found a technique capable of improving characteristics such as a loss, an inductance, and DC superimposition characteristics and reducing the size.

According to various aspects of the present disclosure, a DC-DC converter and a power supply circuit with improved characteristics and reduced size are provided.

Hereinafter, embodiments of the present disclosure will be described in detail with reference to the accompanying drawings. In the description, the same reference numerals are used for the same elements or elements having the same functions, and redundant description will be omitted.

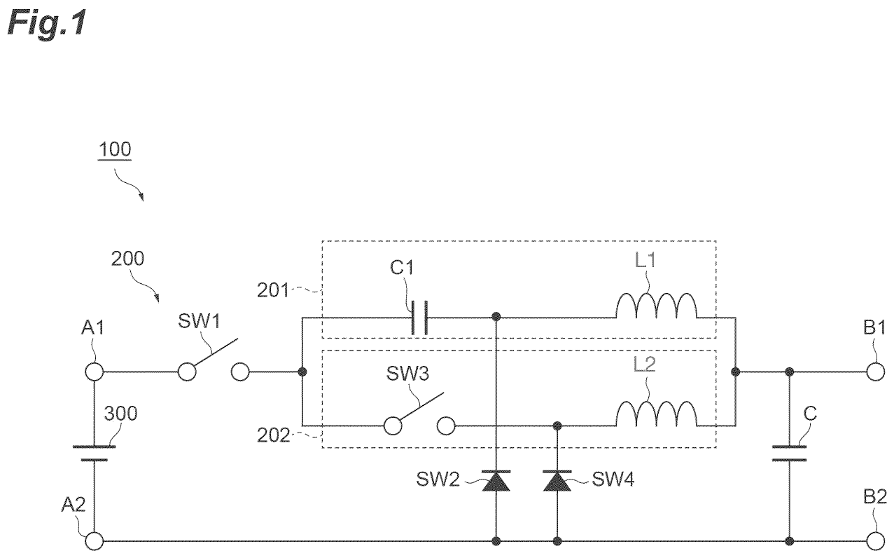

A circuit configuration of a power supply circuit 100 according to one embodiment will be described with reference to FIG. 1.

The power supply circuit 100 includes a DC-DC converter 200 and an input power supply 300.

The DC-DC converter 200 is a two-phase step-down DC-DC converter. The DC-DC converter 200 has a pair of input terminals A1 and A2, and a pair of output terminals B1 and B2. The pair of input terminals A1 and A2 consist of a first input terminal A1 and a second input terminal A2. The pair of output terminals B1 and B2 consist of a first output terminal B1 and a second output terminal B2. The second input terminal A2 and the second output terminal B2 constitute a ground line.

A first switching element SW1 is connected to the first input terminal A1. A first circuit 201 and a second circuit 202 are connected in parallel between the first switching element SW1 and the first output terminal B1. The first circuit 201 includes a first capacitor C1 and a first inductor L1 connected in series. The first capacitor C1 and the first inductor L1 are arranged in this order from the side closer to the first switching element SW1. A second switching element SW2 configured by a diode is connected in a reverse direction between the connection point of the first capacitor C1 and the first inductor L1 and the ground line. The second circuit 202 includes a third switching element SW3 and a second inductor L2 connected in series. The third switching element SW3 and the second inductor L2 are arranged in this order from the side closer to the first switching element SW1. A fourth switching element SW4 configured by a diode is connected in a reverse direction between the connection point of the third switching element SW3 and the second inductor L2 and the ground line. A second capacitor C2 is connected between the first output terminal B1 and the second output terminal B2.

The first switching element SW1 and the third switching element SW3 may be configured by a transistor, for example. The first switching element SW1 and the third switching element SW3 are alternately turned on and off by a control circuit (not shown), thereby generating an output voltage stepped down from an input voltage. In the DC-DC converter 200 in the present embodiment, the first capacitor C1 has a function of dividing the input voltage by half, and a switching loss and an output voltage ripple are reduced. Therefore, the DC-DC converter 200 is a two-phase step-down DC-DC converter with a function of capacitor voltage dividing. The second switching element SW2 and the fourth switching element SW4 may be configured by a transistor instead of the diode.

The input power supply 300 is connected to the pair of input terminals A1 and A2 of the DC-DC converter 200 and input a DC voltage between the input terminals A1 and A2. The voltage input from the input power supply 300 to the DC-DC converter 200 may be 10V or more.

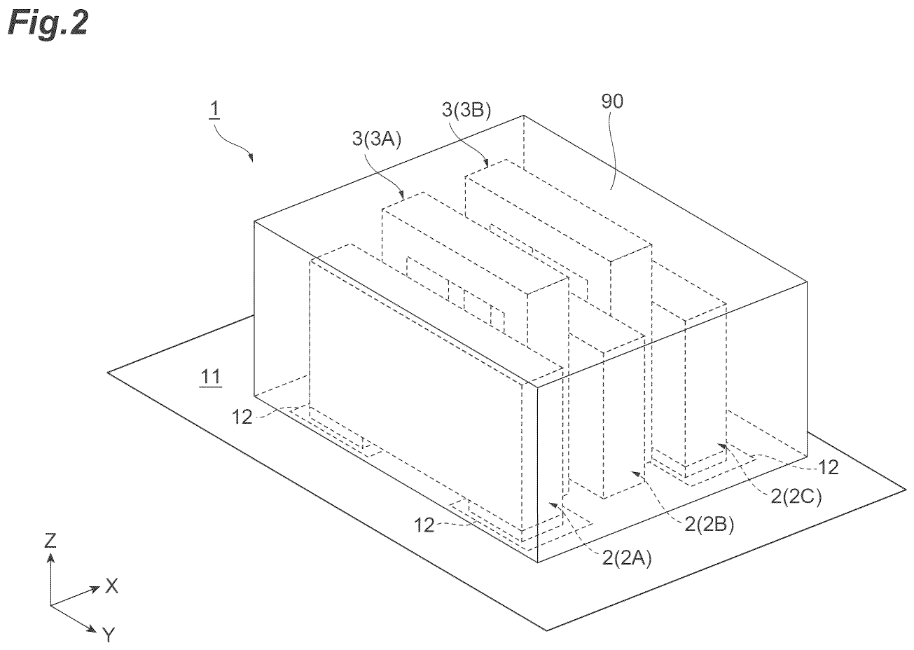

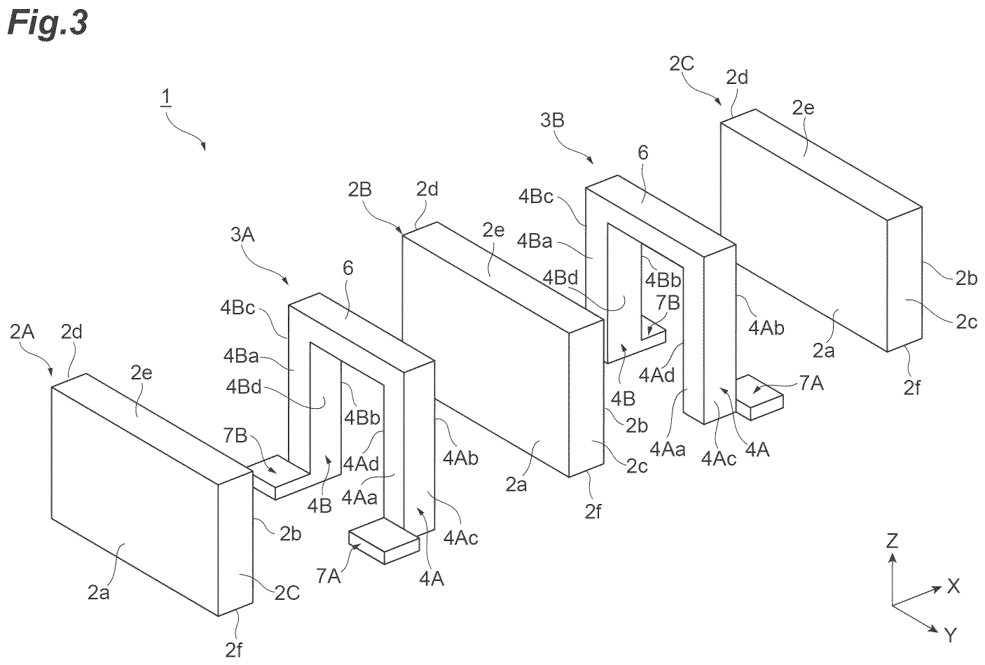

An inductance element 1 used in each of the two inductors L1 and L2 included in the DC-DC converter 200 will be described with reference to FIGS. 2 and 3. FIG. 2 is a perspective view of the inductance element, and FIG. 3 is an exploded view of the inductance element. In FIG. 2, the inductance element 1 is mounted on a substrate 11.

The inductance element 1 is configured with an element body 90, magnetic blocks 2 and coil conductors 3 disposed within the element body 90. The magnetic blocks 2 as cores and the coil conductors 3 are stacked in the X direction.

As shown in FIG. 2, the inductance element 1 includes the element body 90 having a rectangular parallelepiped outer shape. In the present embodiment, the outer shape of the element body 90 is configured by three pairs of surfaces facing each other in the X direction, the Y direction, and the Z direction. The element body 90 may be configured with magnetic resin. The magnetic resin is resin containing a magnetic powder, and is a bound powder in which magnetic powder is bound by binder resin, for example.

The inductance element 1 internally includes the three magnetic blocks 2 and the two coil conductors 3 in the element body 90.

The three magnetic blocks 2 consist of a first magnetic block 2A, a second magnetic block 2B and a third magnetic block 2C. The first magnetic block 2A, the second magnetic block 2B and the third magnetic block 2C are arranged and separated from each other in the X direction in this order and in a face-to-face manner. Each of the magnetic blocks 2 has a rectangular parallelepiped shape. In the present embodiment, each of the magnetic blocks 2 has a rectangular parallelepiped shape that is flat in the X direction. The magnetic blocks 2 have the same shape. The magnetic characteristics of the magnetic blocks 2 may be substantially the same or different.

Each of the three a magnetic blocks 2A to 2C has a pair of main surfaces 2a and 2b, a pair of end surfaces 2c and 2d, and a pair of side surfaces 2e and 2f. The main surfaces 2a and 2b face each other in the X direction. The main surface 2a is arranged on the negative side in the X direction, and the main surface 2b is arranged on the positive side in the X direction. The end surfaces 2c and 2d face each other in the Y direction. The end surface 2c is arranged on the positive side in the Y direction, and the end surface 2d is arranged on the negative side in the Y direction. The side surfaces 2e and 2f face each other in the Z direction. The side surface 2e is arranged on the positive side in the Z direction, and the side surface 2f is arranged on the negative side in the Z direction.

As shown in FIG. 1, the magnetic blocks 2A to 2C are disposed at the same position in the Y-Z plane such that each of the end surfaces and each of the side surfaces overlap each other when viewed from the X direction. A positional deviation within a range caused by manufacturing error or the like is regarded as the “same position” in the present disclosure.

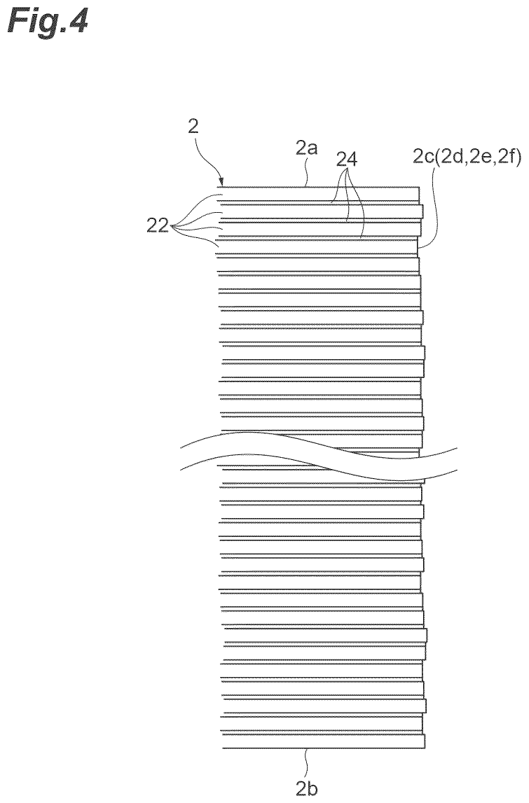

As shown in FIG. 4, each of the magnetic blocks 2 includes a plurality of magnetic thin strips 22 (more specifically, a ribbon made of metallic soft magnetic material) laminated in the Z direction, and has a laminated structure with a plurality of the magnetic thin strips 22 and a plurality of adhesive layers 24 laminated alternately. The main surfaces 2a and 2b of each of the magnetic blocks 2 may be configured with the magnetic thin strip 22 or the adhesive layer 24. The number of layers of the magnetic thin strips 22 constituting each of the magnetic blocks 2 is, for example, 120. The magnetic thin strip 22 is, for example, an amorphous ribbon or a nanocrystalline ribbon. The magnetic thin strip 22 may be configured with magnetic alloys such as amorphous alloys, microcrystalline alloys, permalloy, alloys having nanoheterostructures, and the like. Examples of the amorphous alloy material include an Fe-based amorphous soft magnetic material and a Co-based amorphous soft magnetic material, and examples of the microcrystalline alloy include an Fe-based nanocrystalline soft magnetic material. The nanoheterostructure refers to a structure where microcrystals are present in an amorphous material.

Each of the magnetic thin strips 22 constituting the magnetic block 2 is handled and laminated so as not to generate a crack. Therefore, each of the magnetic thin strips 22 does not substantially have a crack. Even if a slight crack occurs in the magnetic thin strip 22, such a crack does not divide the magnetic thin strip 22 into small pieces. In addition, even if a part of the magnetic thin strip 22 is divided due to cracking or chipping in manufacturing, such a part is not regarded as a small piece divided by cracking.

The two coil conductors 3 consists of a first coil conductor 3A and a second coil conductor 3B. The first coil conductor 3A and the second coil conductor 3B are arranged along the X direction with the second magnetic block 2B interposed therebetween. The first coil conductor 3A is arranged between the first magnetic block 2A and the second magnetic block 2B, and the second coil conductor 3B is arranged between the second magnetic block 2B and the third magnetic block 2C. The material of the coil conductor 3 is configured by, for example, a metal or metals selected from Cu, Ag, Au, Al, Ni, Sn, and the like.

The first coil conductor 3A includes a first conductive portion 4A, a second conductive portion 4B, a connecting portion 6, a first terminal portion 7A, and a second terminal portion 7B.

The conductive portions 4A and 4B extend in the Z direction and are parallel to each other. The conductive portions 4A and 4B are arranged between the first magnetic block 2A and the second magnetic block 2B in the X direction. The first conductive portion 4A is arranged on the positive side in the Y direction, and the second conductive portion 4B is arranged on the negative side in the Y direction. The conductive portions 4A and 4B may not be parallel to the Z direction as long as they extend along the Z direction.

The first conductive portion 4A includes a pair of facing surfaces 4Aa and 4Ab, and a pair of side surface 4Ac and 4Ad. The pair of facing surfaces 4Aa and 4Ab face each other in the X direction. The facing surface 4Aa arranged on the positive side in the X direction faces the first magnetic block 2A in the X direction. The facing surface 4Ab arranged on the negative side in the X direction faces the second magnetic block 2B in the X direction. The side surfaces 4Ac and 4Ad face each other in the Y direction. The side surface 4Ac is arranged on the positive side in the Y direction, and the side surface 4Ad is arranged on the negative side in the Y direction. The second conductive portion 4B has a pair of facing surfaces 4Ba and 4Bb, and a pair of side surfaces 4Bc and 4Bd. The pair of facing surfaces 4Ba and 4Bb face each other in the X direction. The facing surface 4Ba arranged on the negative side in the X direction faces the first magnetic block 2A in the X direction. The facing surface 4Bb arranged on the positive side in the X direction faces the second magnetic block 2B in the X direction. The side surfaces 4Bc and 4Bd face each other in the Y direction. The side surface 4Bc is arranged on the negative side in the Y direction, and the side surface 4Bd is arranged on the positive side in the Y direction.

The connecting portion 6 is a portion that connects the first conductive portion 4A and the second conductive portion 4B. The connecting portion 6 is connected to one ends of the conductive portions 4A and 4B (i.e., ends on the positive side in the Z direction) and extends in the Y direction. The connecting portion 6 may not be parallel to the Y direction as long as the connecting portion 6 extends along the Y direction.

The first terminal portion 7A is provided at the other end (i.e., an end on the negative side in the Z direction) of the first conductive portion 4A, and extends toward the negative side in the X direction and the positive side in the Y direction. The first terminal portion 7A is configured by forming a part near the other end of the first conductors 4A to be wider toward the positive side in the Y direction and bending the wider part toward the negative side in the X direction. The second terminal portion 7B is provided at the other end (i.e., an end on the negative side in the Z direction) of the second conductive portion 4B, and extends toward the negative side in the X direction and the negative side in the Y direction. The second terminal portion 7B is configured by forming a part near the other end of the second conductive portion 4B to be wider toward the negative side in the Y direction, and bending the wider part toward the negative side in the X direction. The first magnetic block 2A adjacent to the first coil conductor 3A on the negative side in the X direction is placed on the terminal portions 7A and 7B of the first coil conductor 3A. The terminal portions 7A and 7B are bonded to the land electrodes 12 of the substrate 11 on which the inductance element 1 is mounted. Thus, the inductance element 1 is mounted on the substrate 11.

Similarly to the first coil conductor 3A, the second coil conductor 3B includes a first conductive portion 4A, a second conductive portion 4B, a connecting portion 6, a first terminal portion 7A, and a second terminal portion 7B. The second coil conductor 3B is different from the first coil conductor 3A in that the first terminal portion 7A extends from the other end of the first conductive portion 4A toward the positive side in the X direction and the positive side in the Y direction, and the second terminal portion 7B extends from the other end of the second conductive portion 4B toward the positive side in the X direction and the negative side in the Y direction. The third magnetic block 2C adjacent to the second coil conductor 3B on the positive side in the X direction is placed on the terminal portions 7A and 7B of the second coil conductor 3B. The terminal portions 7A and 7B of the second coil conductor 3B are also bonded to the land electrodes 12 of the substrate 11 on which the inductance element 1 is mounted.

The surfaces on the negative side in the Z direction of the terminal portions 7A and 7B of the first coil conductor 3A and the terminal portions 7A and 7B of the second coil conductor 3B are exposed from the element body 90, and the exposed portions are bonded to the land electrodes 12. A part of the surfaces adjacent to the disposed surface on the negative side in the Z direction of the terminal portions 7A and 7B of the first coil conductor 3A and the terminal portions 7A and 7B of the second coil conductor 3B may be exposed from the element body 90.

As an example, the first coil conductor 3A of the inductance element 1 is used for the first inductor L1 and the second coil conductor 3B of the inductance element 1 is used for the second inductor L2.

The inventors have found that characteristics improvement and size reduction can be achieved by applying the coil conductors 3A and 3B of the inductance element 1 to the DC-DC converter 200. Therefore, verification was performed by the experiment shown below.

In the experiment, for comparison, an inductance element (referred to as a “cracked element”) including magnetic blocks configured with magnetic thin strips in which numerous cracks are generated was prepared, in addition of an inductance element (referred to as a “crack-free element”) including magnetic blocks configured with crack-free magnetic thin strips as shown in FIG. 2. The crack-free element and the cracked element had the same inductance value 0.2 μH and the same DC superposition saturation current 13A [Isat,−30%]. In this time, the height (3.5 mm) of the crack-free element obtaining the same inductance value and the same DC superposition saturation current was smaller than the height (3.8 mm) of the cracked element.

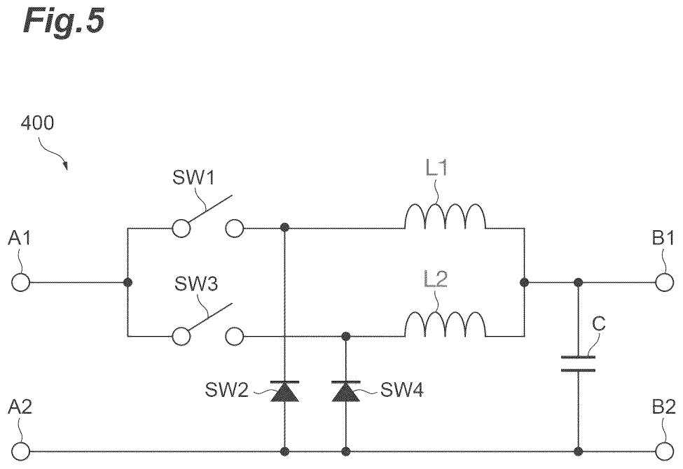

For comparison, a two-phase step-down DC-DC converter 400 not having the function of capacitor voltage dividing shown in FIG. 5 was prepared, in addition to the two-phase step-down DC-DC converter 200 having the function of capacitor voltage dividing shown in FIG. 1.

In Comparative Example 1, the coil conductor of the crack-free device was applied to the inductor L1 and the L2 of the DC-DC converter 400 shown in FIG. 5. In Comparative Example 2, the coil conductor of the cracked device was applied to the inductors L1 and L2 of the DC-DC converter 400 shown in FIG. 5. In the embodiment, the coil conductor of the crack-free device is applied to the inductors L1 and L2 of the DC-DC converter 200 shown in FIG. 1.

In Comparative Examples 1 and 2 and Example, as the same input voltage 12V and the same output voltage 1.0V, the loss (Pc) [mW] were measured. The loss of the inductor was measured with a BH analyzer, and the loss under the driving condition was calculated. As a result, the loss in Comparative Example 1 was 406 mW, the loss in Comparative Example 2 was 320 mW, and the loss in Example was 308 mW.

As described above, in the DC-DC converter 200 of the power supply circuit 100, characteristics can be improved in view of loss reduction by using the coil conductors 3A and 3B in the inductance element 1 as the inductors L1 and L2.

In addition, since the inductance element 1 includes the magnetic blocks 2 configured with crack-free the magnetic thin strips 22, it is possible to reduce the size (in particular, the height) while maintaining the device characteristics such as the inductance value and the DC superposition saturation current, as compared with the case of including magnetic blocks configured with magnetic thin strips in which numerous cracks are generated. On the contrary, when the size of the magnetic block 2 is maintained, by including the magnetic blocks configured with crack-free magnetic thin strips in the inductance element 1, the element characteristics such as the inductance value and the DC superposition saturation current may be improved, as compared with the case where the inductance element includes the magnetic blocks configured with the magnetic thin strips in which numerous cracks are generated.

The coil conductors 3A and 3B of the inductance element 1 may be used for both of the inductors L1 and L2 in the DC-DC converter 200, or one of the coil conductors 3A and 3B may be used for one of the inductors L1 and L2.

When the coil conductor 3A and 3B of the inductance element 1 are used for both of the inductors L1 and L2 in the DC-DC converter 200, the inductors L1 and L2 can be configured in one inductance element 1, so that the DC-DC converter 200 can be downsized. In addition, since the magnetic block 2B is arranged between the coil conductors 3A and 3B corresponding to the inductors L1 and L2 respectively in the DC-DC converter 200, the coupling of the inductors L1 and L2 is suppressed, and as a result, the occurrence of ripples can be suppressed. Further, the coupling of the inductor L1 and L2 is suppressed by the first magnetic block 2A and the third magnetic block 2C and the inductance value is improved.

The step-down ratio of the DC-DC converter 200 can be determined as appropriate. However, when the step-down ratio is 0.1 or less, the influence of the radio frequency loss is large because the harmonic components are large. Although the switching frequency of the DC-DC converter 200 can be determined as appropriate, the switching frequency with 100 kHz or more greatly affect the radio frequency loss. Since the magnetic thin strips configuring the magnetic block 2 tends to have a large radio frequency loss, an increase in loss can be suppressed according to the DC-DC converter 200.

The input voltage of the input power supply 300 may be 10V or more. The higher the input voltage, the greater the loss of the inductance element 1. According to the DC-DC converter 200, an increase in loss can be suppressed.

What is claimed is:

1. A DC-DC converter comprising:
a first input terminal and a second input terminal;
a first output terminal and a second output terminal;
a first switching element connected to the first input terminal;
a first circuit provided between the first switching element and the first output terminal, and including a first capacitor and a first inductor connected in series in this order and a second switching element connected between the first capacitor and the first inductor;
a second circuit provided between the first switching element and the first output terminal in parallel with the first circuit, and including a third switching element and a second inductor connected in series in this order and a fourth switching element connected between the third switching element and the second inductor; and
a second capacitor connected between the first output terminal and the second output terminal,
wherein at least one of the first inductor and the second inductor is an inductance element including a first coil conductor, a magnetic body adjacent to the first coil conductor, and a magnetic resin internally including the first coil conductor and the magnetic body,
wherein the magnetic body has a laminated structure with a plurality of magnetic thin strips laminated, and each magnetic thin strip is not divided into small pieces by a crack.

2. The DC-DC converter according to claim 1, wherein the inductance element includes the first coil conductor configuring one of the first inductor and the second inductor, and further includes a second coil conductor configuring the other of the first inductor and the second inductor,
wherein the second coil conductor is internally included in the magnetic resin and is adjacent to the magnetic body.

3. The DC-DC converter according to claim 2, wherein the magnetic body of the inductance element is interposed between the first coil conductor and the second coil conductor.

4. The DC-DC converter according to claim 2, wherein the magnetic body of the inductance element includes a first magnetic block, a second magnetic block, and a third magnetic block,
wherein the first magnetic block is interposed between the first coil conductor and the second coil conductor, the second magnetic block is disposed on an opposite side of the first magnetic block side with respect to the first coil conductor, and the third magnetic block is disposed on an opposite side of the first magnetic block side with respect to the second coil conductor.

5. The DC-DC converter according to claim 1, wherein the step-down ratio is 0.1 or less.

6. The DC-DC converter according to claim 1, wherein the switching frequency is 100 kHz or more.

7. A power supply circuit comprising the DC-DC converter according to claim 1, and an input power supply configured to input a DC voltage of 10V or more between the first input terminal and the second input terminal.
